(19) United States
(12) Patent Application Publication
(10) Pub. No.: US 2024/0271826 A1
(43) Pub. Date: Aug. 15, 2024

(54) Tankless Water Heating Systems and Methods that Include a First Energy Source and a Battery

(71) Applicant: Rheem Manufacturing Company, Atlanta, GA (US)

(72) Inventors: Christopher Mark Hayden, Shelton, CT (US); Anthony Hurgoi, Boston, MA (US); Thanh Hoang Dao, West Hartford, CT (US); Harsha Satyanarayana, Norwalk, CT (US)

(21) Appl. No.: 18/435,808

(22) Filed: Feb. 7, 2024

Related U.S. Application Data
(60) Provisional application No. 63/484,038, filed on Feb. 9, 2023.

(51) Int. Cl. F24H 15/168; F24H 15/108; F24H 15/219; F24H 15/238; H02J 7/00

(52) U.S. Cl. CPC F24H 15/168; F24H 15/108; F24H 15/219; F24H 15/238; H02J 7/0063

(57) ABSTRACT

A water heating system is disclosed. The system may include a water heater connected with a utility energy source via one or more circuit breakers. The system may further include a battery and a detection unit. The battery may provide energy to the water heater, and the detection unit may detect water demand associated with the system. The system may additionally include a controller configured to activate the water heater in a first operation mode when the water demand is less than a predefined threshold. The water heater may heat water by using energy drawn from the utility energy source in the first operation mode. The controller may further activate the water heater in a second operation mode when the water demand is greater than the predefined threshold. The water heater may draw energy from the utility energy source and the battery in the second operation mode.

### CROSS-REFERENCE TO RELATED APPLICATIONS

This is a continuation application of and claims priority to and benefit of U.S. provisional patent application No. 63/484,038 filed Feb. 9, 2023, which is herein incorporated by reference.

### FIELD

The present disclosure relates to water heating systems and methods and more particularly to tankless water heating systems and methods for heating water by using energy drawn from a first energy source (e.g., a utility) and/or a second energy source (e.g., a battery).

### BACKGROUND

Tankless water heating systems generally heat water by using energy drawn from an electric panel connected with a utility energy source. Based on the water heating system size and water demand, electric tankless water heating systems may use 50 to 200 Ampere of electric current to heat water. Such systems typically draw electric energy from the electric panels via three or more typical circuit breakers. Circuit breakers ensure uninterrupted system operation and prevent system damage when there are fluctuations in energy supply.

There may be instances where the electric panels installed at residential, commercial, and/or industrial facilities may not have three circuit breakers available for use. For example, one or more of the circuit breakers may be dedicated to other electronic systems. In such instances, installation of tankless water heating systems may be not be possible without installation of additional circuit breakers, which may not be economically practical.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a schematic diagram of an example water heating system in accordance with one or more embodiments of the present disclosure.

FIG. 2 depicts a block diagram of a controller in accordance with one or more embodiments of the present disclosure.

FIG. 3 depicts a flow diagram of an example first water heating method in accordance with one or more embodiments of the present disclosure.

FIG. 4 depicts a flow diagram of an example second water heating method in accordance with one or more embodiments of the present disclosure.

### DETAILED DESCRIPTION

The present disclosure is directed towards tankless water heating systems and methods for heating water by using energy drawn from a first energy source (e.g., a utility energy source) and/or a second energy source (e.g., a battery). In some instances, the tankless water heating system may include a tankless water heater, a battery, and a controller. The tankless water heater may draw electric energy from the utility energy source via one or more circuit breakers. The controller may detect water demand from the tankless water heating system and may activate the tankless water heater to operate in one of three operation modes responsive to water demand detection.

For example, in certain embodiments, the controller may activate the tankless water heater in a first operation mode when the controller detects that the water demand is less than a predefined threshold. In the first operation mode, the tankless water heater may heat water by using energy drawn from only the utility energy source via the one or more circuit breakers. The water demand may be associated with a water flow rate from the tankless water heating system, and/or the water demand may be associated with a desired water temperature. For example, the controller may detect that the water demand may be less than the predefined threshold when the water flow rate from the tankless water heating system is less than a flow rate threshold. In other instances, the controller may detect that the water demand may be less than the predefined threshold when the desired water temperature is less than a temperature threshold.

In certain embodiments, the controller may activate the tankless water heater in a second operation mode when the controller detects that the water demand is greater than the predefined threshold. For example, the controller may detect that the water demand is greater than the predefined threshold when the water flow rate exceeds the flow rate threshold. In other instances, the controller may detect that the water demand is greater than the predefined threshold when the desired water temperature exceeds the temperature threshold. In the second operation mode, the tankless water heater may heat water by using energy drawn from the utility energy source and energy drawn from the battery. Stated another way, in the second operation mode, the energy drawn from the battery may supplement the energy drawn from the utility energy source to heat water in the tankless water heater.

In some embodiments, the tankless water heating system may include one battery. In this case, the tankless water heater may draw electric power from the utility energy source via two circuit breakers. In other aspects, the tankless water heating system may include two batteries. In this case, the tankless water heater may draw electric power from the utility energy source via one circuit breaker. Any number of batteries may be used herein. In some instances, each battery may be the equivalent of and/or replace one circuit breaker.

In certain embodiments, the controller may activate the tankless water heater in a third operation mode when the controller detects a disruption in energy supply from the utility energy source (and a non-zero water flow rate). The controller may detect the disruption, for example, when there is a power cut or outage. In the third operation mode, the tankless water heater may heat water by using energy drawn from the one or more batteries.

The controller may be further configured to charge the battery by using energy drawn from the utility energy source. In other instances, the controller may be further configured to charge the battery by using energy drawn from one or more renewable energy sources (e.g., solar energy, hydro energy, wind energy, and/or the like). Any suitable renewable energy source may be used herein. In one example, the controller may charge the battery by using energy drawn from the utility energy source during off-peak time durations of water demand. For example, the controller may charge the battery during nighttime when the demand for heated water may typically be low.

In this manner, the present disclosure is directed to a tankless water heating system that may be configured to heat water by using energy drawn from a utility energy source and/or a battery. In some instances, the tankless water heating system does not require connection to the utility energy source via three circuit breakers. As a result, the tankless water heating system may be installed at residential, commercial, and/or industrial facilities having electric panels with less than three available circuit breakers. Further, the tankless water heating system may heat water even when there is disruption in energy supply from the utility energy source, e.g., during a power cut or outage.

In certain embodiments, the tankless water heating system may also, in some instances, be used to provide energy to other devices that are connected to the utility energy source via a local grid. For example, if the tankless water heating system is provided in a residential home, the tankless water heating system may provide energy used to charge a vehicle, appliance, and/or any other type of device in the residential home. However, this may be applicable beyond residential homes as well.

For alternating current (AC) power delivery, the tankless water heating system may be provided with an inverter, which may include some control logic used to provide overdraw protection. The control logic of the inverter may also be used to reserve a certain percentage of battery power that may be drawn by the tankless water heater to allow the tankless water heater to provide a minimum level of hot water supply operation. The control logic may also be used to determine when the one or more batteries are used to supply power to the tankless water heater instead of other devices connected to the utility energy source. For example, if both the tankless water heater and another device demand power, then the control logic may prioritize providing power to the tankless water heater (however, the distribution of power between the tankless water heater and other deices may also be prioritized in any other suitable manner). This logic may also be implemented at the controller of the tankless water heater as well, which may control operation of the inverter.

For direct current (DC) power delivery, the one or more batteries may include terminals to which different types of devices may be connected to draw energy directly from the one or more batteries. Alternatively, a device may sent a request for power to the controller of the tankless water heater, and the controller may control supply of energy from the one or more batteries to the device. For example, this approach may be implemented using a Modbus communication protocol used by the tankless water heater or in any other suitable manner.

Further, in certain embodiments, the one or more batteries may be used to provide a more immediately supply of hot water from a gas water heater as well. Gas water heaters take time to heat up which causes a delay in providing hot water. To overcome this limitation, a smaller heating element may be provided at the gas water heater. The smaller heating element may be connected to a power source and used to provide more immediate hot water for low demand events and for an initial startup of the gas water heater. These smaller heating elements may typically require a 220V power source for operation (for example, if the water heater is provided in a residential home, a 220V outlet may be required for operation of the heating element). In other words, a heating element may draw as much as 80 amps or more during operation (this current value may vary depending on the heating element). This may require multiple 120V circuits (e.g., each circuit has a 20 amp breaker) or one 220 V circuit (e.g., each circuit has a 100 amp breaker). However, a gas water heater may be installed at a location in which a 220V power source is not accessible, but a 120V power source is accessible. To allow for the use of the smaller heating element even without having access to the 220V power source, the 120V power source may be used to trickle charge the one or more batteries. The one or more batteries may then be used to power the smaller heating element to provide the more immediate supply of hot water, even without access to the 220V power source. In this example, the battery is able to supply the full 80 amps (or any other amount of current required for operation of the heating element) of current required to power the heating element for at least a limited amount of time (based on the capacity of the battery and the state of charge of the battery).

This same approach may generally be applicable to any other combination of voltage levels and any other current draw of the heating element as well. That is, the one or more batteries may be used to provide energy to the heating element when a sufficient power source is otherwise not accessible.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a system and method for heating water in a tankless water heating system that may heat water by using energy drawn from a utility energy source and/or a battery. The tankless water heating system may include an electric water heater, a gas water heater, a heat pump water heater, and/or the like, configured to heat the water. The present disclosure, however, is not so limited and can be applicable in other contexts. Furthermore, the present disclosure can include other fluid heating systems configured to heat a fluid other than water such as process fluid heaters used in industrial applications. Such implementations and applications are contemplated within the scope of the present disclosure. Accordingly, when the present disclosure is described in the context of being a system and method for heating water in a tankless water heating system, it will be understood that other implementations can take the place of those referred to.

Although the term “water” is used throughout this specification, it is to be understood that other fluids may take the place of the term “water” as used herein. Therefore, although described as a water heating system, it is to be understood that the systems and methods described herein can apply to fluids other than water. Further, it is also to be understood that the term “fluid” can replace the term “water” as used herein unless the context clearly dictates otherwise. The fluid heating systems may include gas furnaces, electric heating elements or the like for heating the fluid.

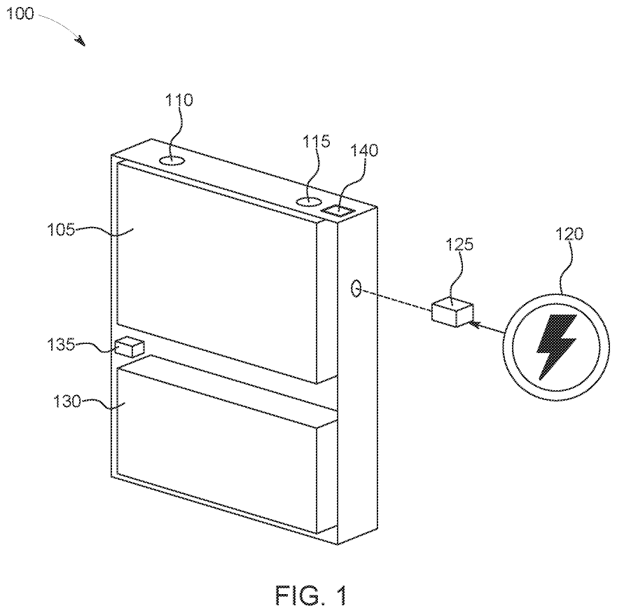

Turning now to the drawings, FIG. 1 depicts a schematic diagram of an example water heating system 100 in accordance with one or more embodiments of the present disclosure. The water heating system 100 may heat water to be used in residential, commercial, and/or industrial applications. In an exemplary aspect, the water heating system 100 may be used in a residential or home set-up and may provide heated water to be used in kitchen, washroom, shower, etc. In certain embodiments, the water heating system 100 may be a tankless water heating system that may include an instant heating tankless water heater 105 (or a water heater 105) connected with an inlet valve 110 and an outlet valve 115. The water heater 105 may receive water supply (e.g., cold water supply from a utility or the like) via the inlet valve 110 and may output heated water via the outlet valve 115.

In some instances, the water heater 105 may be an electric tankless water heater. In other instances, the water heater 105 may be a gas tankless water heater. In yet other instances, the water heater 105 may be a tankless water heater that utilizes a heat pump or the like. In certain embodiments (e.g., an electric tankless water heater and/or a tankless water heater that utilizes a heat pump), the water heater 105 may be configured to heat water by using energy drawn from a utility energy source 120 via one or more circuit breakers 125. The utility energy source 120 may be an electric utility source and may provide electric energy to the water heater 105. In one example, the water heater 105 may be a 9.6 Kilowatts (KW) electric water heater. In other examples, the water heater 105 may have any other configuration that may be suitable for a particular system application.

Although FIG. 1 depicts one circuit breaker 125, in some instances, the water heater 105 may be connected with the utility energy source 120 via two or more circuit breakers 125. Any suitable number or type of circuit breaker may be used herein. In one example, the circuit breaker 125 may be a 40 Ampere, 240 Volt circuit breaker. The water heater 105 may be connected with the circuit breaker 125 by using a typical wired connection. The circuit breaker 125 may ensure uninterrupted system operation and prevent system damage when there are fluctuations in energy supply from the utility energy source 120.

The water heating system 100 may further include a battery 130 that may be configured to provide energy, e.g., electric energy, to the water heater 105. The battery 130 may also be connected with the water heater 105 by using a typical wired connection. In one example, the battery 130 may be a 70 Ampere-hour battery and may be configured to supplement the energy provided by the utility energy source 120 to the water heater 105. In some instances, the battery 130 may be a phase change material (PCM) based battery. Any suitable battery may be used herein. For example, the battery 130 may be a lithium-ion battery, solid-state battery, etc.

Although FIG. 1 depicts one battery 130, in some instances, the water heating system 100 may include two or more batteries 130. Any suitable number or type of batteries may be used herein. In one example, when the water heating system 100 includes two batteries, the water heating system 100 may be connected with the utility energy source 120 via one circuit breaker 125. In other instances, when the water heating system 100 includes one battery, the water heating system 100 may be connected with the utility energy source 120 via two circuit breakers 125. In other aspects, based on battery configuration (e.g., a larger battery with higher Ampere-hour capacity), the water heating system 100 may include a single battery 130 and may be connected with the utility energy source 120 via one circuit breaker 125. Any suitable combination and number of circuit breakers and batteries may be used herein.

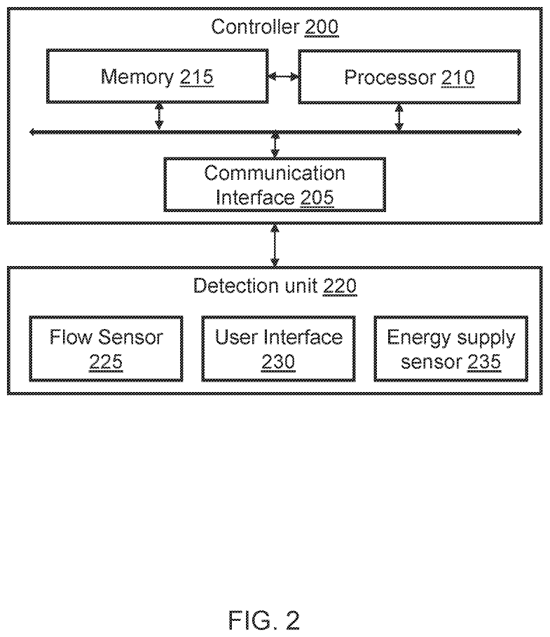

The water heating system 100 may further include a controller 135, a flow sensor 140, and a user interface (shown as user interface 230 in FIG. 2). The user interface 230 may be disposed remotely from the water heating system 100 or may be disposed on or in proximity to the water heating system 100. For example, the user interface 230 may be part of a user app on a user device (e.g., a smart device or the like). In other instances, the user interface 230 may be part of and disposed on the water heater 105. In one example, a user may input a desired water temperature on the user interface 230. For example, the user may input 100 degree Fahrenheit or 87 degree Fahrenheit as the desired water temperature on the user interface 230.

The flow sensor 140 may be disposed in proximity to the outlet valve 115 (as shown in FIG. 1) and/or in proximity to the inlet valve 110. The flow sensor 140 may be configured to measure water flow rate from the outlet valve 115 (or water input into the inlet valve 110).

The water heating system 100 may include additional sensors or components. Examples of such additional sensors or components include, but are not limited to, a pressure sensor, a scale, a voltmeter, an ammeter, a power meter, an ohmmeter, a resistance temperature detector, environment condition sensors including ambient air temperature sensors, humidity sensors, an energy supply sensor (shown as energy supply sensor 235 in FIG. 2), and/or the like. Some of these additional sensors or components are not shown in FIG. 1 for the sake of simplicity and conciseness.

In one example, the energy supply sensor may be configured to detect a disruption in energy supply to the water heater 105 from the utility energy source 120, e.g., during a power cut.

The controller 135 may be communicatively connected with the water heater 105, the battery 130, and the sensors/components described above and may be configured to control system operation. Specifically, the controller 135 may be configured to activate the water heater 105 to operate in one or more operation modes (e.g., one of the three operation modes) based on one or more parameters, including, but not limited to, the desired water temperature, the water flow rate from the water heating system 100, disruption in energy supply from the utility energy source 120, and/or the like. For example, the controller 135 may select an operation mode from the one or more operation modes and activate the water heater 105 in the selected operation mode. In a first operation mode, the water heater 105 may heat water by using energy drawn only from the utility energy source 120. In a second operation mode, the water heater 105 may heat water by using energy drawn from both the utility energy source 120 and the battery 130. In a third operation mode, the water heater 105 may heat water by using energy drawn only from the battery 130. The details of the controller 135 may be understood in conjunction with FIG. 2.

FIG. 2 depicts a block diagram of a controller 200 in accordance with one or more embodiments of the present disclosure. The controller 200 may be same as the controller 135 described in conjunction with FIG. 1. The controller 200 may include a plurality of components, including, but not limited to, a communication interface 205, a processor 210, and memory 215. The controller 200 may be a computing device configured to receive data, determine actions based on the received data, and output a control signal instructing one or more system components to perform one or more actions. As discussed above, the controller 200 may be a part of the water heating system 100, and the controller 200 may be in communication with at least some of the system components.

In some aspects, the controller 200 may be configured to send and receive wireless or wired signals, and the signals may be analog or digital signals. The wireless signals may include Bluetooth™, BLE, WiFi™, ZigBee™, infrared, microwave radio, laser, or any other type of wireless communication signals as may be suitable for a particular system application. The hard-wired signals can include communication signals between any directly wired connections between the controller 200 and other system components. For example, the controller 200 can have a hard-wired 24 Volts Direct Current (VDC) connection to the sensors/components described above in conjunction with FIG. 1.

Alternatively, the controller 200 may communicate with the sensors/components installed in the water heating system 100 via a digital connection. The digital connection can include a connection such as an Ethernet or a serial connection and can utilize any suitable communication protocol for the system application, such as Modbus, fieldbus, PROFIBUS, SafetyBus, Ethernet/IP, and/or the like. Furthermore, the controller 200 can utilize a combination of wireless, hard-wired, and analog or digital communication signals to communicate with and control the various system components. The above configurations are given merely as non-limiting examples and the actual configuration can vary depending on the particular system application.

In certain embodiments, the controller 200 may be configured to communicate, via the communication interface 205, with a detection unit 220 that may be part of the water heating system 100. The detection unit 220 may include a flow sensor 225, a user interface 230, and an energy supply sensor 235. The flow sensor 225 may be the same as the flow sensor 140 described in conjunction with FIG. 1. Further, as described in conjunction with FIG. 1, the user may input the desired water temperature on the user interface 230. The user interface 230 may be a system Human Machine Interface (HMI) configured to display system information and receive inputs from the user. The user interface 230 may be installed locally on the water heating system 100 or may be installed remotely (e.g., as an app or the like on a portable user device).

The energy supply sensor 235 may be configured to detect presence or absence of energy supply from the circuit breaker 125 or the utility energy source 120 to the water heater 105. For example, the energy supply sensor 235 may detect absence of energy supply from the utility energy source 120 to the water heater 105 when there may be a power cut. Further, the energy supply sensor 235 may detect resumption of energy supply from the utility energy source 120 when the energy supply resumes after the power cut.

The memory 215 may be configured to store a program and/or instructions associated with the functions and methods described herein. The processor 210 may be configured to execute the program and/or instructions stored in the memory 215. The memory 215 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory 215.

The communication interface 205 may be configured to send or receive communication signals between the various system components. The communication interface 205 can include hardware, firmware, and/or software that allows the processor 210 to communicate with the other components via wired or wireless networks, whether local or wide area, private or public, as known in the art. The communication interface 205 can also provide access to a cellular network, the Internet, a local area network, or another wide-area network as suitable for the particular system application.

In operation, the processor 210 may obtain, via the communication interface 205, water demand associated with the water heating system 100 from the detection unit 220. Specifically, the processor 210 may obtain water flow rate from the flow sensor 225 and the desired water temperature from the user interface 230. The water flow rate and the desired water temperature may collectively indicate water demand associated with the water heating system 100. Any suitable methods and associated components may be used to determine water demand.

Responsive to obtaining the water demand, the processor 210 may determine whether the water demand is less than a predefined threshold (that may be pre-stored in the memory 215) and is greater than zero (i.e., non-zero). Specifically, the processor 210 may determine whether the desired water temperature and the water flow rate are less than respective water temperature threshold and water flow rate threshold. For example, the processor 210 may determine whether the desired water temperature is less than 87 degree Fahrenheit and the water flow rate is less than 1.8 Gallons per minute (GPM). In an exemplary aspect, the water temperature threshold may be in a range of 82 to 95 degree Fahrenheit, and the water flow rate threshold may be in a range of 1.5 to 2.5 GPM.

Responsive to determining that the water demand is less than the predefined threshold (e.g., both the desired water temperature and the water flow rate are less than respective thresholds), the processor 210 may send, via the communication interface 205, a first activation signal to the water heater 105 to operate in the first operation mode. In the first operation mode, the water heater 105 may heat water by using energy drawn only from the utility energy source 120 via the circuit breaker 125 (or multiple circuit breakers).

The processor 210 may send, via the communication interface 205, a second activation signal to the water heater 105 to operate in a second operation mode when the processor 210 detects a trigger event. In some aspects, the trigger event may include detecting that the water demand is increasing and is greater than the predefined threshold. Stated another way, the processor 210 may detect the trigger event when the processor 210 determines that the water demand has increased greater than the predefined threshold based on the water flow rate obtained from the flow sensor 225 and/or the desired water temperature from the user interface 230. Specifically, the processor 210 may determine that the water demand has increased greater than the predefined threshold when either the desired water temperature exceeds the water temperature threshold and/or when the water flow rate exceeds the water flow rate threshold. For example, the processor 210 may detect the trigger event when the water flow rate increases to 3 GPM and/or when the desired water temperature increases to 100 degree Fahrenheit. In some aspects, the processor 210 may detect the trigger event when the water flow rate increases greater than the water flow rate threshold (which may be in a range of 1.5 to 2.5 GPM) and/or when the desired water temperature increases greater than the water temperature threshold (which may be in a range of 82 to 95 degree Fahrenheit).

Responsive to receiving the second activation signal from the processor 210, the water heater 105 may operate in the second operation mode (or may “switch” operation from the first operation mode to the second operation mode). In the second operation mode, the water heater 105 may heat water by using energy drawn from both the utility energy source 120 (via the one or more circuit breakers 125) and the battery 130 (or batteries). In this case, the battery 130 may supplement the energy provided by the utility energy source 120 and provide additional energy to the water heater 105 to cater to the higher water demand. In this manner, the water heating system 100 may not require additional circuit breakers to supply electric energy to the water heating system 100 from the utility energy source 120 when the water demand is high. Instead, the battery 130 may offset the need for one or more additional circuit breakers.

In certain embodiments, the processor 210 may detect the trigger event when there may be a disruption in energy supply from the utility energy source 120. Stated another way, the processor 210 may detect the trigger event when the processor 210 obtains an energy disruption signal from the energy supply sensor 235. In one example, the energy disruption signal may indicate a power cut or power outage. In this case, responsive to obtaining the energy disruption signal, the processor 210 may send, via the communication interface 205, a third activation signal to the water heater 105 to operate in a third operation mode. In the third operation mode, the water heater 105 may heat water by using energy drawn only from the battery 130 (or batteries). In this manner, the water heating system 100 may heat water (and hence dispense heated water from the outlet valve 115) even when there may be a power cut from the utility energy source 120.

The processor 210 may again send the first or the second activation signal to the water heater 105 (based on water flow rate and the desired water temperature) when the energy supply resumes from the utility energy source 120 after the power cut. Specifically, in this example, the processor 210 may receive an energy resumption signal from the energy supply sensor 235 when the energy supply resumes from the utility energy source 120 after the power cut. Responsive to receiving the energy resumption signal, the processor 210 may activate the water heater 105 in the first or the second operation mode.

In certain embodiments, the processor 210 may be configured to cause charging of the battery 130 (or batteries) by using energy drawn from the utility energy source 120 and/or one or more renewable sources of energy (e.g., solar energy, hydro energy, wind energy, etc.). For example, the processor 210 may charge the battery 130 by using energy drawn from the utility energy source 120 during off-peak time duration (e.g., during nighttime or when the water flow rate is zero for a predefined time duration threshold (e.g., 3 hours)). In some instances, the processor 210 may be configured to obtain, via the communication interface 205, utility pricing for different time durations of the day from a utility energy source server or the like. In this manner, the processor 210 may charge the battery 130 by using energy drawn from the utility energy source 120 at time durations when the utility pricing is less than a predefined pricing threshold (that may be pre-stored in the memory 215).

In some instances, the processor 210 may be configured to obtain weather data from one or more system sensors (e.g., environment condition sensors) and may charge the battery 130 by using solar energy when the weather data indicates abundant sun light/solar energy and/or via wind energy when the weather data indicates abundant wind. In other instances, the processor 210 may charge the battery 130 by drawing energy from independent power storage or batteries (e.g., power backs or battery packs, such as the Powerwall™ from Tesla™ or the like) that may be installed at residential, commercial, or industrial facilities. In some instances, the independent power storage or batteries may be used in addition to or supplement the battery 130 in the second or third operation modes.

In certain embodiments, the battery 130 may be configured to supply a low energy supply continuously (or at a predefined frequency) to the water heater 105 to keep the system warm. The low energy supply may prevent the water heating system 100 from freezing, and hence the water heating system 100 may be installed outside of residential, commercial, or industrial facilities.

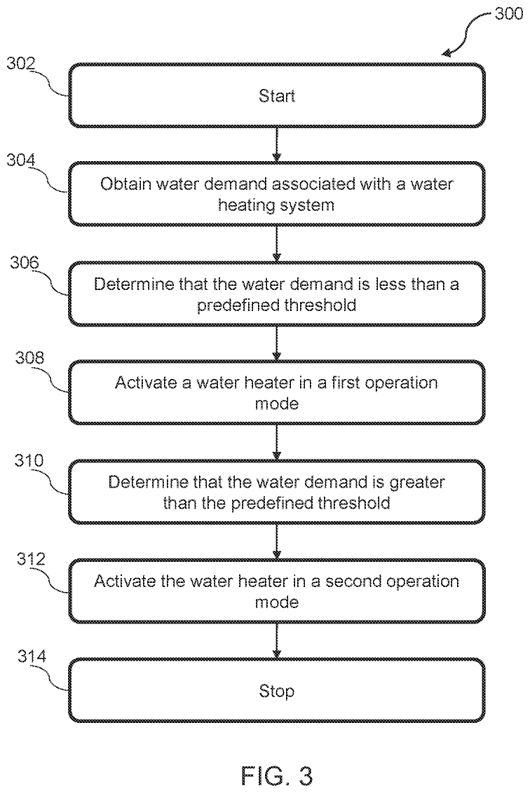

FIG. 3 depicts a flow diagram of an example water heating method 300 in accordance with one or more embodiments of the present disclosure. FIG. 3 may be described with continued reference to prior figures, including FIGS. 1-2. The following process is exemplary and not confined to the steps described hereafter. Moreover, alternative embodiments may include more or less steps that are shown or described herein and may include these steps in a different order than the order described in the following example embodiments.

The method 300 starts at step 302. At step 304, the method 300 may include obtaining, by the processor 210, water demand associated with the water heating system 100 from the detection unit 220. Specifically, as described in conjunction with FIG. 2, the processor 210 may obtain the water flow rate from the flow sensor 225 and the desired water temperature from the user interface 230, which may individually or collectively indicate the water demand associated with the water heating system 100.

Responsive to obtaining the water demand, the processor 210 may determine that the water flow rate is non-zero. Responsive to determining that the water flow rate is non-zero, at step 306, the processor 210 may determine that the water demand is less than the predefined threshold. In some instances, the processor 210 may determine that the water demand is less than the predefined threshold when the water flow rate and/or the desired water temperature are less than respective water flow rate threshold and water temperature threshold.

At step 308, the method 300 may include activating, by the processor 210, the water heater 105 in the first operation mode responsive to determining that the water demand is less than the predefined threshold. As described in conjunction with FIG. 2, the water heater 105 may heat water by using energy drawn only from the utility energy source 120 in the first operation mode. In this manner, a sufficient number of circuit breakers may be available to operate the water heater 105 in the first operation mode based on the water demand.

At step 310, the method 300 may include determining, by the processor 210, that the water demand is greater than the predefined threshold. Specifically, the processor 210 may determine that the water demand is greater than the predefined threshold when the water flow rate and/or the desired water temperature exceed respective water flow rate threshold and water temperature threshold.

At step 312, the method 300 may include activating, by the processor 210, the water heater 105 in the second operation mode responsive to determining that the water demand is greater than the predefined threshold. In the second operation mode, the water heater 105 may heat water by using energy drawn from both the utility energy source 120 and the battery 130.

At step 314, the method 300 may end.

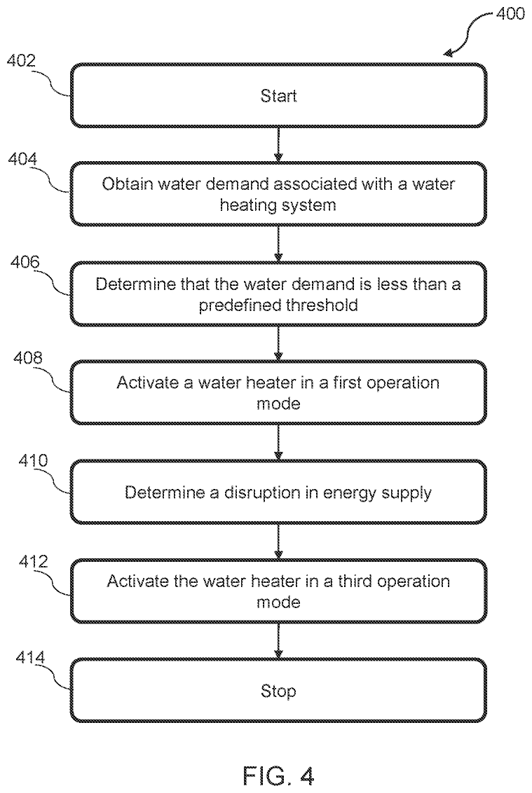

FIG. 4 depicts a flow diagram of an example water heating method 400 in accordance with one or more embodiments of the present disclosure. FIG. 4 may be described with continued reference to prior figures, including FIGS. 1-3. The following process is exemplary and not confined to the steps described hereafter. Moreover, alternative embodiments may include more or less steps that are shown or described herein and may include these steps in a different order than the order described in the following example embodiments.

The method 400 starts at step 402. Steps 404, 406 and 408 of the method 400 may be same as the steps 304, 306 and 308 of the method 300 and are not described again here for the sake of simplicity and conciseness.

At step 410, the method 400 may include determining, by the processor 210, a disruption in energy supply from the utility energy source 120. As described in conjunction with FIG. 2, the processor 210 may determine the disruption in the energy supply when the processor 210 obtains the energy disruption signal from the energy supply sensor 235.

Responsive to determining the disruption in the energy supply from the utility energy source 120, at step 412, the processor 210 may activate the water heater 105 in a third operation mode. As described in conjunction with FIG. 2, the water heater 105 may heat water by using energy drawn only from the battery 130 (or batteries) in the third operation mode.

At step 414, the method 400 may end.

Methods 300 and 400 may include additional steps of charging the battery 130 by using the energy from the utility energy source 120 and/or one or more renewable energy sources. For example, as described in conjunction with FIG. 2, the processor 210 may charge the battery 130 by using the energy from the utility energy source 120 during off-peak time durations (e.g., when water flow rate may be zero or low).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A water heating system comprising:
a water heater connected with a utility energy source;
a battery connected with the water heater, wherein the battery is configured to provide energy to the water heater;
a detection unit configured to detect water demand associated with the water heating system; and
a controller communicatively coupled with the water heater, the battery, and the detection unit, wherein the controller is configured to:
obtain, from the detection unit, the water demand;
activate, based on the water demand, the water heater in a first operation mode;
detect, by the detection unit, a trigger event; and
activate, based on the trigger event, the water heater in a second operation mode.

2. The water heating system of claim 1, further comprising a heating element, wherein the utility energy source provides a first amount of current to the heating element, wherein the first amount of current is less than a second amount of current required for operation of the heating element, wherein the battery is charged using the utility energy source, and wherein the battery is used to provide the second amount of current for operation of the heating element.

3. The water heating system of claim 1, wherein the water heater is a tankless water heater configured to heat water by using energy drawn from the utility energy source and/or the energy drawn from the battery.

4. The water heating system of claim 1, wherein the water heater is connected with the utility energy source via a circuit breaker.

5. The water heating system of claim 1, wherein the water demand is associated with at least one of: a water flow rate from the water heating system or a desired temperature of output water from the water heating system.

6. The water heating system of claim 1, wherein the controller is configured to:
determine that the water demand is less than a predefined threshold; and
activate, based on the water demand being less than the predefined threshold, the water heater in the first operation mode, wherein the water heater is configured to heat water by using energy drawn from only the utility energy source in the first operation mode.

7. The water heating system of claim 6, wherein detecting the trigger event comprises determining that the water demand is greater than the predefined threshold.

8. The water heating system of claim 7, wherein the water heater is configured to heat water by using energy drawn from the utility energy source and the battery in the second operation mode.

9. The water heating system of claim 1, wherein detecting the trigger event comprises determining a disruption in energy supply from the utility energy source.

10. The water heating system of claim 9, wherein the water heater is configured to heat water by using energy drawn from the battery in the second operation mode.

11. The water heating system of claim 1, wherein the controller is configured to charge the battery by using energy from the utility energy source.

12. The water heating system of claim 1, wherein the controller is configured to charge the battery by using energy from a renewable energy source.

13. A water heating method comprising:
obtaining, by a controller, water demand associated with a water heating system from a detection unit, wherein the water heating system comprises:
a water heater connected with a utility energy source, and
a battery connected with the water heater, wherein the battery is configured to provide energy to the water heater;
activating, by the controller and based on the water demand, the water heater in a first operation mode;
detecting, by the controller and based on the detection unit, a trigger event; and
activating, by the controller and based on the trigger event, the water heater in a second operation mode.

14. The water heating method of claim 13, wherein the water demand is associated with a water flow rate from the water heating system.

15. The water heating method of claim 13, wherein the water demand is associated with a desired temperature of output water from the water heating system.

16. The water heating method of claim 13 further comprising:
determining that the water demand is less than a predefined threshold; and
activating, based on the water demand being less than the predefined threshold, the water heater in the first operation mode, wherein the water heater is configured to heat water by using energy drawn from only the utility energy source in the first operation mode.

17. The water heating method of claim 16, wherein detecting the trigger event comprises determining that the water demand is greater than the predefined threshold.

18. The water heating method of claim 17, wherein the water heater is configured to heat water by using energy drawn from both the utility energy source and the battery in the second operation mode.

19. The water heating method of claim 13 further comprising charging the battery by using energy from the utility energy source.

20. A non-transitory computer-readable storage medium having instructions stored thereupon which, when executed by a processor, cause the processor to:
obtain water demand associated with a water heating system from a detection unit, wherein the water heating system comprises:
a water heater connected with a utility energy source, and
a battery connected with the water heater, wherein the battery is configured to provide energy to the water heater;
activate the water heater in a first operation mode responsive to obtaining the water demand;
detect a trigger event; and
activate the water heater in a second operation mode responsive to detecting the trigger event.
